(19) United States
(12) Patent Application Publication
(10) Pub. No.: US 2009/0101075 A1
(43) Pub. Date: Apr. 23, 2009

(54) COVER FOR A PET CARRIER

(76) Inventor: Carolyn Birckhead Matlack, Mooresville, NC (US)

Correspondence Address: ADAMS INTELLECTUAL PROPERTY LAW, P.A., Suite 2350 Charlotte Plaza, 201 South College Street, CHARLOTTE, NC, 28244, US

(21) Appl. No.: 12/189,235

(22) Filed: Aug. 11, 2008

Related U.S. Application Data
(60) Provisional application No. 60/999,811, filed on Oct. 19, 2007.

(51) Int. Cl. A01K 1/03; E05D 5/00

(52) U.S. Cl. 119/497; 160/181; 119/501

(57) ABSTRACT

A cover for enclosing a pet container is provided. The cover includes a panel having a front, rear, pair of side, and center flaps configured to cover a front, rear, pair of sides and top of a generally rectangular pet container. The panel also includes a first attachment clip located on a perimeter of the panel and a second attachment clip positioned on the center of the panel such that the front, rear, and pair of side flaps may be folded onto the center flap, and the clips are aligned such that once the flaps are folded the clips may be fastened together.

### CROSS REFERENCE TO RELATED APPLICATION

This application claims priority to U.S. Provisional Patent Application No. 60/999,811 that was filed on Oct. 19, 2007.

### TECHNICAL FIELD AND BACKGROUND OF THE INVENTION

The present invention generally relates to a cover for a pet carrier. The cover provides insulation and storage of pet related items around the pet carrier.

Conventional pet carriers are disadvantageous for a variety of reasons. Many pet carriers have nowhere to store information about the pet, the pet's medical records, ownership status, or necessary pet goods. Still other carriers do not offer thermal insulation. Conventional pet carriers have used a cover to offer storage of medical records or thermal insulation. However, conventional covers do not always provide the pet with an appropriate viewing range. Conventional fabric covers also fail to provide adequate drainage or ventilation characteristics. In addition, many conventional fabric covers failed to provide a suitable method for carrying the cover. Finally conventional fabric covers are often difficult to install on a pet carrier because a person would have to place the entire carrier into the fabric enclosure.

Accordingly there is a need for a pet cover that is easily attached on a pet container, provides an adequate viewing range, is easy carried, provides insulation and storage of pet products and emergency records. The Pet Grab n' Go® was conceived to address these needs.

### SUMMARY OF THE INVENTION

It is an object of the invention to provide a cover for a pet container.

It is another object to provide a cover with pockets.

It is another object to provide a cover that is easily secured to a pet container.

It is another object to provide a cover that insulates the pet.

It is another object to provide a cover that is reversible and double sided.

It is another object to provide a cover that is able to store safety and emergency information.

It is another object to provide a cover that is capable of being hung or stowed away for storage.

It is another object to provide a cover that may also be used as a luggage accessory.

These and other objects and advantages of the present invention are achieved in the preferred embodiments set forth below by providing a cover for enclosing a pet container. The cover includes a panel having a front, rear, pair of side, and center flaps that is configured to cover a front, rear, pair of sides and top of a generally rectangular pet container. The panel also includes a first attachment clip located on a perimeter of the panel and a second attachment clip positioned on the panel such that the front, rear, and pair of side flaps may be folded onto the center flap, with the clips being aligned such that once the flaps are folded the clips may be fastened together. The cover may then be carried by a bag strap handle in a luggage like fashion.

According to another embodiment of the present invention, the cover includes a slot positioned within the center.

According to another embodiment, the cover includes a flexible strap having a first end fixed to the center of the cover and a second end configured to be placed through the slot and an opening in the container, and the strap then secured to the cover for providing a handle to transport the container.

According to another embodiment, the cover includes a pocket for storing goods.

According to another embodiment, the cover is insulative.

According to another embodiment, the cover includes reflective tape.

According to another embodiment, the cover includes touch fastener elements on the top, front and rear flaps positioned such that the front and rear flaps may be rolled onto the center and secured in place by the touch fastener elements, thereby leaving the front or rear surface of the pet container unobstructed and providing increased ventilation.

According to another embodiment, the slot is configured to be aligned with a handle of the container, thereby allowing a handle of the container to extend into the slot and above the cover.

According to another embodiment, a cover for enclosing a pet container includes a panel having a front, rear, pair of side, and center flaps and is configured to cover a front, rear, sides, and top of a generally rectangular pet container. The cover also includes a slot positioned within the center of the cover, and a strap connected with the cover and configured to be positioned through a plurality of openings of the pet container, thereby securing the cover to the container and providing for a handle for the container.

According to another embodiment, the strap defines a length and width direction, and is adjustable in the length direction.

According to another embodiment, the cover is porous.

According to another embodiment, the cover is water proof.

According to another embodiment, the cover includes a bag strap handle positioned on the cover and positioned such that the bag strap handle provides a handle for carrying the cover once the front, rear, and pair of side flaps are folded onto the center flap, wherein the cover resembles a briefcase once the front, rear, and pair of side flaps are folded onto the center flap.

According to another embodiment, a pet carrying apparatus is provided and includes a pet container for housing a pet and a cover. The cover includes a panel having a front, rear, pair of side, and center flaps configured to cover a front, rear, pair of sides and top of a generally rectangular pet container, and a first attachment clip located on a perimeter of the panel and a second attachment clip positioned on the panel such that the front, rear, and pair of side flaps may be folded onto the center flap, with the clips being aligned such that once the flaps are folded the clips may be fastened together.

According to another embodiment, the pet container includes a door connected, thereby allowing for egress and ingress of a pet.

According to another embodiment, the pet container further includes a handle located centrally about a top of the container, and the cover further includes a slot configured such that the handle is aligned with the slot, thereby allowing a handle of the container to extend into the slot and above the cover.

### BRIEF DESCRIPTION OF THE DRAWINGS

Some of the objects of the invention have been set forth above. Other objects and advantages of the invention will appear as the description of the invention proceeds when taken in conjunction with the following drawings, in which:

FIG. 1 shows a pet carrying apparatus according to the present invention;

FIG. 2 shows one side of the cover according to the present invention; and

FIG. 3 shows another side of the cover according to the present invention.

### DETAILED DESCRIPTION OF PREFERRED EMBODIMENTS AND BEST MODE

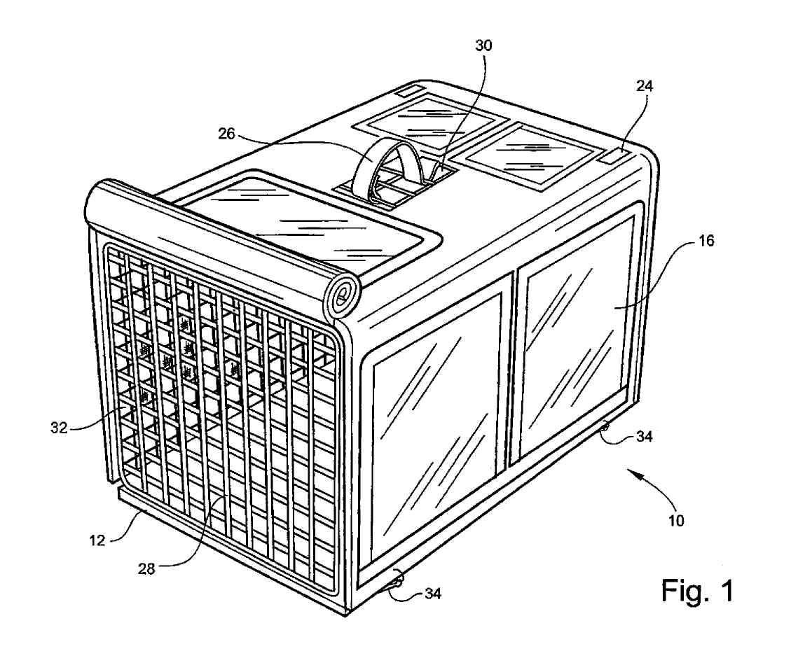

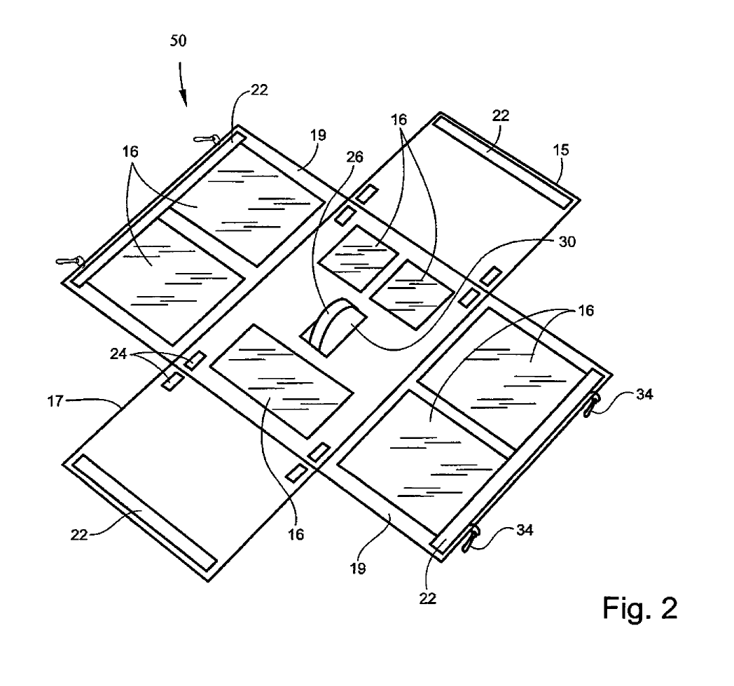

Referring now to the drawings where like referenced elements are represented by like referenced numerals, a pet carrying apparatus is shown in FIGS. 1-3 and identified as reference numeral 10. The pet carrying apparatus is a rectangular prism and includes a panel having a double sided cover 14 placed around the container 12. The container 12 has a plurality of openings 32 for providing ventilation and visibility of the pet containment system. The container 12 also has a door 28 that allows a pet owner to open and shut the container 12 as desired. The cover 14 includes a handle 26 that may be wrapped through the plurality of openings for securing the cover 14 to the container 12. The handle 26 engages with the container 12 through an opening 30 in the container. Pockets 16 are provided on one side of the cover 14. The pockets 16 may be laminated pockets as shown in FIG. 1 for storing documents. The cover also includes reflective strips 22. A front flap 17 of the cover is shown rolled up onto the top of the container and better shown in FIG. 2. The front flap 17 and a rear flap 18 are secured to the top of the container by touch fastener strips 24.

As best shown in FIG. 2, a clip 35 is provided on the exterior of the cover and another clip 35 about a center flap 15 and each clip 35 is positioned such that the cover 14 can be folded by folding each corresponding flap onto the center flap 15 until each clip 35 is aligned and the cover 14 can be fastened into one compressed square shaped member. In this manner, a bag strap handle 29 can be used for carrying the folded and clipped cover 14 and the folded assembly will generally resemble a briefcase.

As shown generally throughout the Figures and specifically in regards to FIG. 2, one side 50 of the cover 14 according to one embodiment is shown, and is preferably the exterior side of the cover 14. The cover 14 includes the center 15 and a pair of side flaps 19, 21. A front flap 17 and rear flap 18 are also attached with the center. Together these flaps form a cross shaped fabric. Each flap is preferably fabricated to approximately the same shape and size as the corresponding side of a container that the fabric will enclose. Touch fastener strips 24 are provided on the front and rear flaps 17, 18 and also on the center 15. The strips 24 are aligned in such a way that the front and rear flaps 17,18 may be rolled onto the center 15 and held in place by the touch fastener strips. Alternatively, the sides may be provided with touch fastener strips 24 and rolled onto the center.

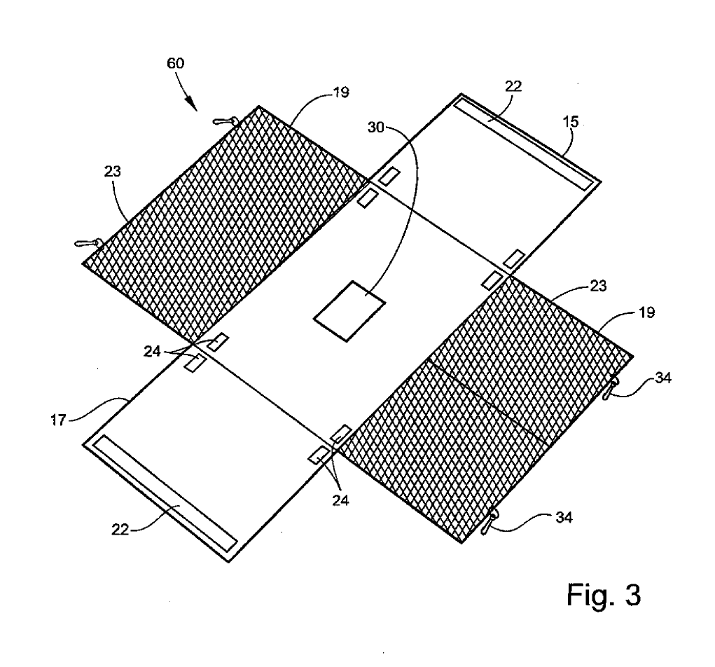

FIG. 3 shows another side 60 of the cover 14 according to another embodiment. Bulk storage pockets 23 are provided for storing bulk items, and may preferably be of a mesh material. The pockets 23 may have an elastic band for holding the mesh taut.

In other embodiments, the container may have a handle located in such a way as to be within the void of the cover 14. In this embodiment, the cover is fastened by strap 26 and attachment clip 27. The cover may have both bulk storage pockets 23 and clear pockets 16 on each side of the cover or in other embodiments have both bulk storage pockets 23 and clear pockets 16 on one side of the cover.

In operation, the cover 14 is placed on top of the container 12. The cover 14 is also fastened through the use of a strap 26 through openings 32 through out the container 12. The strap 26 is secured to the container 12 through the use of the attachment clip 27 designed to hold the strap 26 secured. In some embodiments, the container 12 may have a handle that is located within the void 30 of the cover 14. The strap 26 may also act as a fastener for securing the cover 14 to the container 12. The bag strap handle 29 is provided to act as a handle for transporting the pet carrier apparatus.

A pet carrying apparatus is described above. Various details of the invention may be changed without departing from its scope. Furthermore, the foregoing description of the preferred embodiment of the invention and the best mode for practicing the invention are provided for the purpose of illustration only and not for the purpose of limiting the invention being defined by the claims.

I claim:

1. A cover for enclosing a pet container, comprising:
(A) a panel having a front, rear, pair of side, and center flaps, and configured to cover a front, rear, pair of sides, and top of a generally rectangular pet container; and
(B) a first attachment clip located on a perimeter of the panel and a second attachment clip located on the panel such that the front, rear, and pair of side flaps may be folded onto the center flap, with the clips being aligned such that once the flaps are folded, the clips may be fastened together.

2. The cover of claim 1, further including a slot positioned within the center of the cover.

3. The cover of claim 2, further including a flexible strap having a first end fixed to the center of the cover and a second end configured to be placed through the slot and an opening in the container for providing a handle for transporting the container.

4. The cover of claim 1, further including a bag strap handle positioned on the cover and positioned such that the bag strap handle provides a handle for carrying the cover once the front, rear, and pair of side flaps are folded onto the center flap, wherein the cover resembles a briefcase once the front, rear, and pair of side flaps are folded onto the center flap.

5. The cover of claim 1, further including reflective tape located on the cover.

6. The cover of claim 1, further including touch fastener elements on the top, front and rear flaps of the cover positioned such that the front and rear flaps may be rolled onto the center and secured in place by the touch fastener elements, thereby leaving the front or rear surface of the pet container unobstructed.

7. The cover of claim 2, wherein the slot is configured to be aligned with a handle of the container, thereby allowing a handle of the container to extend into the slot and above the cover.

8. A cover for enclosing a pet container, comprising:
(A) a panel having a front, rear, pair of side, and center flaps configured to cover a front, rear, pair of sides, and top of a generally rectangular pet container;
(B) a slot positioned within the center of the cover; and
(C) a strap connected with the cover and configured to be positioned through a plurality of openings of the pet container, thereby securing the cover to the container and providing for a handle for the container.

9. The cover of claim 8, wherein the strap defines a length and width direction, and is adjustable in the length direction.

10. The cover of claim 8, wherein the cover is porous.

11. The cover of claim 8, wherein the cover is water proof.

12. The cover of claim 8, further including at least one pocket located on the cover for storing documents or bulk items.

13. The cover of claim 8, further including a first attachment clip located on a perimeter of the panel and a second attachment clip positioned on the panel such that the front, rear, and pair of side flaps may be folded onto the center flap, with the clips being aligned such that once the flaps are folded the clips may be fastened together.

14. The cover of claim 8, further including reflective tape on the cover.

15. The cover of claim 8, further including touch fastener elements on the top, front, and rear flaps of the cover positioned such that the front and rear flaps may be rolled onto the center and secured in place by the touch fastener elements, thereby leaving the front or rear surface of the pet container unobstructed.

16. A pet carrying apparatus, comprising:
(A) a pet container for housing a pet;
(B) a cover including a panel having a front, rear, pair of side, and center flaps, and configured to cover a front, rear, pair of sides, and top of a generally rectangular pet container; and
(C) a first attachment clip located on a perimeter of the cover and a second attachment clip positioned on the cover such that the front, rear, and pair of side flaps may be folded onto the center flap, with the clips being aligned such that once the flaps are folded the clips may be fastened together.

17. The pet carrying apparatus according to claim 16, further including a door connected with the front of the container, thereby allowing for egress and ingress of a pet.

18. The pet carrying apparatus according to claim 16, wherein the container further includes a handle located centrally about a top of the container, and the cover further includes a slot configured such that the handle is aligned with the slot, thereby allowing a handle of the container to extend into the slot and above the cover.

19. The pet carrying apparatus according to claim 16, further including pockets located on the cover.

20. The pet carrying apparatus according to claim 16, wherein the cover includes a strap connected with the cover and configured to be positioned through a plurality of openings of the pet container, thereby securing the cover to the container and providing for a handle for the container.
